(19) United States
(12) Patent Application Publication
(10) Pub. No.: US 2008/0261741 A1
(43) Pub. Date: Oct. 23, 2008

(54) Multistage Planetary Gear

(75) Inventor: Anders Peter Kolstrup, Valby (DK)

Correspondence Address: WILLIAM J. SAPONE;COLEMAN SUDOL SAPONE P.C., 714 COLORADO AVENUE, BRIDGE PORT, CT, 06605, US

(73) Assignee: ROTREX A/S, Herlev (DK)

(21) Appl. No.: 10/585,812

(22) PCT Filed: Jan. 21, 2005
(86) PCT No.: PCT/DK2005/000041

§ 371 Date: Jul. 10, 2008

(30) Foreign Application Priority Data
Jan. 22, 2004 (DK) PA 2004 00081

(51) Int. Cl. F16H 3/44; F16H 15/56

(52) U.S. Cl. 475/154; 475/297

(57) ABSTRACT

When, according to the invention, a multistage planetary gear is constructed with a clutch/brake device (8, 21, 22) and these devices are constructed as remote-controlled or automatically operating clutches/brakes, it is possible to construct multistage gears which are compact, and which are reliable in operation. The gear stages are configured as cooperating tooth engagements (6, 6.1, 6.2) on rotating parts, which ensures the function at high speeds of rotation and allows transfers of great power.

### STATE OF THE ART

The invention relates to a multistage planetary gear incorporated in a gear housing and comprising an outer ring, planet wheels and a sun shaft.

Planetary gears of this type are used in particular where high speeds and transfers of great power are needed. Compressors for internal combustion engines may be mentioned as an example.

An example of a two-stage gear of the planetary gear type is known from U.S. Pat. No. 6,609,505, which gear is useful for the driving of a centrifugal charger for an internal combustion engine.

This gear is composed of two entire planetary gears which are interconnected such that selected parts of the gear may be braked. This, however, is a relatively complicated gear to manufacture, and since many elements are incorporated in the gear, it is also subject to great wear which may cause break-down, just as the efficiency is reduced correspondingly. Finally, the gear takes up much space because of its structure.

A planetary gear for high speeds is moreover known from WO 02/064997, which gear, however, does not have a gear ratio that can exceed 13.6:1 because of the three planet wheels which will make physical contact with each other at higher gearings.

### OBJECT OF THE INVENTION

The object of the invention is to improve known multistage gears with the objective of making the gears compact, operationally reliable and suitable for extremely high speeds and transfer of high moments.

This is achieved according to the invention by a multistage planetary gear, wherein a clutch is mounted between the driving part of the gear and the outer ring, which clutch, in the engaged state, transfers the driving movement to a toothed rim provided on the planet shaft, while, in the disengaged state, it transfers the movement directly to the outer ring.

A compact two-stage gear may be constructed in this simple manner, where the transfer of the moment is utilized in the traction between the outer ring and the planet wheels, as described in WO 02/064997, when the clutch is not activated. Upon activation, the movement will be transferred via the gear transmission, which will result in a high gearing corresponding to the configuration of the gear wheel engagement.

When, as stated in claim 2, the clutch is constructed as an electromagnetic clutch, it may be remote-controlled and thereby be controlled by an external controller.

When, as stated in claim 3, the planet shaft is used for the gear wheel engagement, a precise and reliable transfer of movement is achieved.

When, as stated in claim 4, the clutch is constructed as a centrifugal clutch, an automatically changing gear in response to the input speed of rotation is achieved.

When, as stated in claim 5, the tracks are distributed evenly, a high transfer of moment via the elements may be ensured.

When, as stated in claim 6, the elements are provided with a tractive force toward the axis of rotation of the gear, a reliable and controllable clutch function is ensured.

When, as stated in claim 7, the gear is provided with two sets of planetary gears and the secondary gear may be engaged and disengaged, an increased gear ratio and speed of the output shaft may be achieved.

When, as stated in claim 8, the gear is constructed to achieve a high resulting output speed, a continuously variable gear ratio may be achieved by means of the clutch when changing between the gears.

When, as stated in claim 9, the gear is constructed with one or more sets of gear stages, variable speeds of the driven mechanical gear may be achieved in a simple manner.

Finally, as stated in claim 10, it is expedient to mount a one-way bearing between the sun shaft and the ring gear to ensure the direction of rotation of the output shaft.

### THE DRAWING

Examples of embodiments according to the invention will be described more fully below with reference to the drawing, in which

FIG. 1 shows a sectional view of the principle in a first embodiment,

FIG. 2 shows a sectional view of the principle in a second embodiment,

FIG. 3 shows an end view of the drive plate with the tracks for the clutch element as shown in FIG. 2,

FIG. 4 shows a schematic diagram of a third embodiment, and

FIG. 5 shows a sectional view of the principle in a fourth embodiment.

### DESCRIPTION OF THE EXEMPLARY EMBODIMENTS

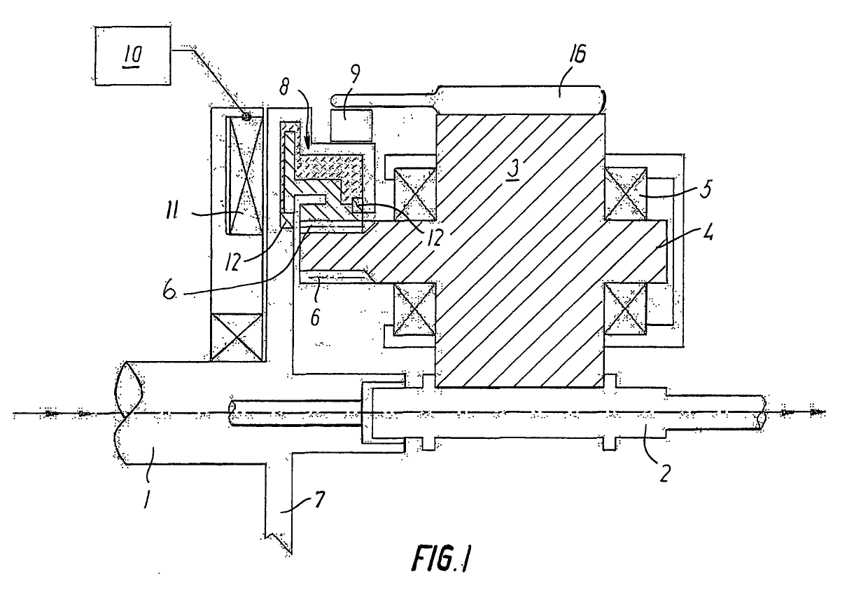

The first exemplary embodiment is indicated in FIG. 1 and shows a planetary gear which is expanded with a ring gear 6 on the stub shafts 4 of the planet wheels 3.

This provides a compact and relatively simple gear at low production costs and with great operational reliability.

As indicated in FIG. 1, the gear comprises a drive shaft, the input shaft 1, which is connected with a drive plate 7.

The clutch 8 comprises a toothed rim 6 on its one clutch part with internal toothing which rotates with the clutch. The clutch is constructed as an electromagnetic clutch which is isolated from the oil in the gear housing by means of gaskets 12.

A coil 11 is mounted on the gear housing, which coil 11 may be activated and controlled by means of a module 10 which allows remote control of the gear.

The movable part of the clutch comprises a magnetic core which will interconnect the parts when the coil 11 is energized.

The planetary gear has an outer ring 16 which drives a set of planet wheels 3, which in turn drive the sun shaft 2. The planet wheels 3 are mounted on the gear housing by means of preferably high speed bearings 5 on both sides.

The clutch part, which rotates with the drive plate 7, is connected with the outer ring 16 via a one-way clutch 9.

The mode of operation of this exemplary embodiment of the gear will be explained now.

When the toothed rim 6 of the clutch 8 is held to the drive plate 7, the output shaft 2 will be connected with the toothed rim 6 because of the tooth engagement with the planet shaft 4. The planet wheels 3 will hereby rotate at a considerably higher speed than the input shaft 1.

Where the clutch 8 is not activated, the input shaft 1 will drive the outer ring 1 via the one-way clutch 9. In this position, the planet wheels 3 are driven at a lower speed of rotation than in the first-mentioned position with engagement.

The output shaft 2 will still rotate faster than the input shaft 1, but not as fast as where the toothed rim is engaged and thereby held.

Other types of clutches may be used instead of the mentioned magnetic clutch 8.

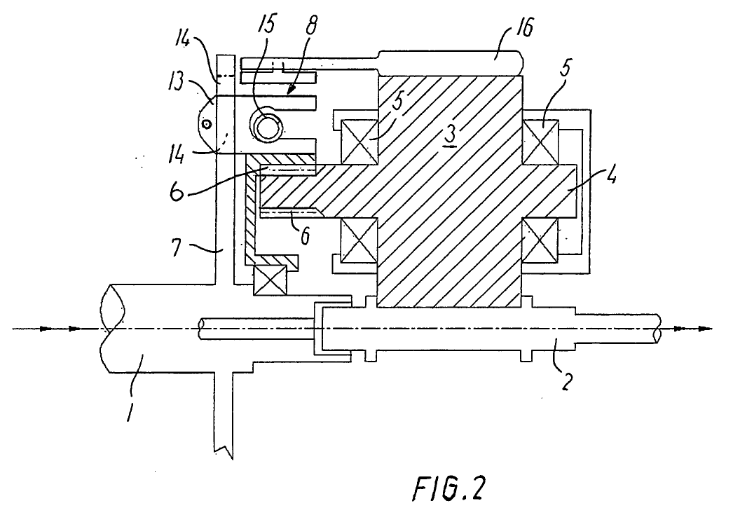

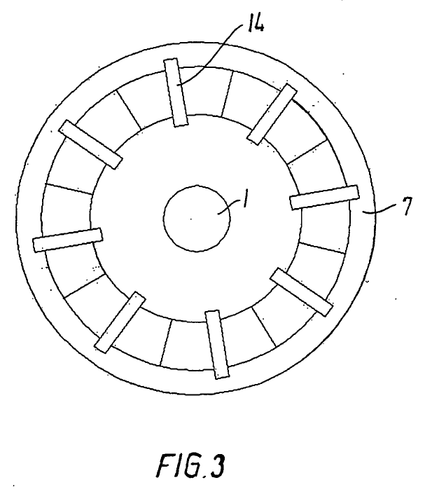

A second exemplary embodiment is shown in FIGS. 2 and 3.

In this example, the clutch 8 is constructed as a centrifugal clutch with elements 13 which may be moved in a radial direction in tracks 14 on the drive plate 7, as shown in FIG. 3.

The input shaft 1 is connected with the drive plate 7, and also a gear system 6 is connected with the drive plate 7.

The elements 13 of the centrifugal clutch have a mass which is adapted to the function of the clutch, and to ensure the mutual position of the individual elements 13 at lower speeds of rotation, there is provided a tensile spring 15 which may extend through all the elements 13, as indicated in FIG. 2.

The effect of this exemplary embodiment will be described now.

When the input shaft 1 rotates at a predetermined low speed, the spring 15 holds the elements 13 against the toothed rim 6 and meshes with it.

The toothed rim 6 is hereby driven by the drive plate 7 with a gearing relative to the planet wheels 3. This results in a significant gearing-up of the planet wheels 3 and thereby of the speed of rotation of the sun shaft 2.

Where the input shaft 1 is given a higher speed which is above the predetermined speed, the elements 13 will overcome the spring force by means of the centrifugal force and move outwards and thereby mesh with the outer ring 16. A direct connection between the input shaft 1 and the outer ring 16 will be established hereby without gearing. This will drive the planet wheels 3 with a lower gearing than at the low speed of rotation, and this ensures that the sun shaft 2 will rotate at a higher speed than the input shaft 1, but still with a lower gear ratio than at the above-mentioned low speed of rotation of the input shaft 1.

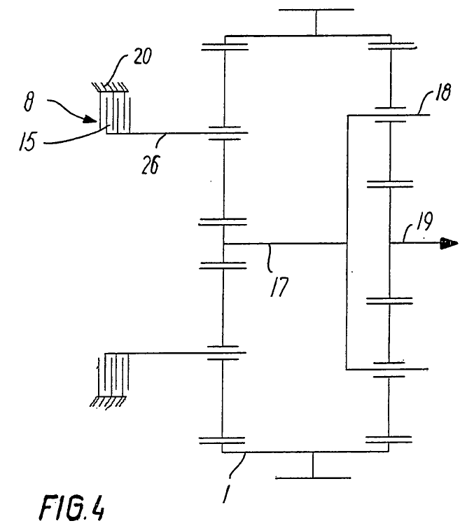

A third exemplary embodiment, which is shown in FIG. 4 in the form of a schematic diagram, will now be described more fully.

The gear comprises a ring gear which also constitutes the input shaft 1, and which is coupled to two sets of planet wheels to form a primary system 26 and a secondary system 18 and with two separate planet wheel holders and two sun wheels 17, 19.

The brake 8, which may be operated from the outside, remote-controlled, has a rotating part 15 which may cause the primary system 26, 17 to rotate freely with the ring gear 1 or, upon engagement, to hold it relative to the gear housing 20.

When the primary system is held, the primary sun wheel 17 is caused to rotate in the opposite direction and with a considerably higher number of revolutions than the input shaft 1.

Via the shaft, the primary sun wheel 17 is firmly connected with the planet wheel holder 18 of the secondary system, which is thereby caused to rotate at the same speed as the speed of the primary sun wheel 17.

The planet wheels moreover cause the secondary sun wheel 19, which is also coupled to the output shaft, to rotate at a considerably higher speed when the primary planet system 26 is held relative to the gear housing 20.

If the controllable clutch 15 is configured with a controllable slip, the gear may operate as a continuously variable gear in this embodiment.

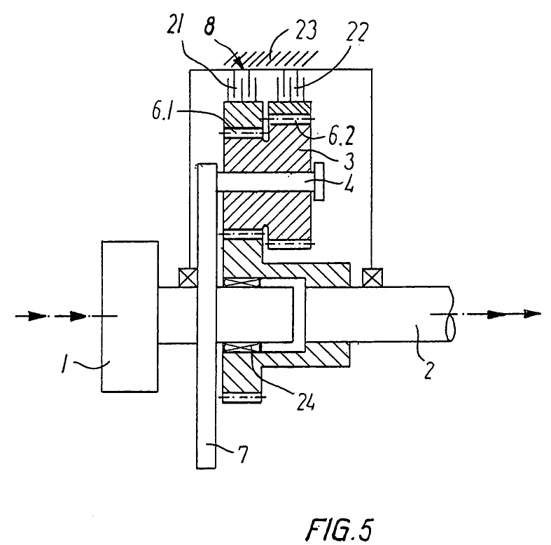

Finally, a fourth exemplary embodiment will be described with reference to FIG. 5, which illustrates an example of a three-stage gear.

The gear is driven by an input shaft 1 which is connected with a drive plate 7 on which the planet wheel shafts 4 are secured.

The planet wheels 3 rotate on these shafts 4, said planet wheels 3 having one or more gear stages. In the example shown, two stages 6.1 and 6.2.

The gear is provided with a brake system 8 which comprises a brake 21, 22 for each gear stage 6.1 and 6.2. Each of the gear stages may hereby be locked individually.

The sun wheel is provided with a one-way coupling 24 to the sun shaft 2.

The mode of operation of this exemplary embodiment will be described now.

When the brakes 21, 22 are not engaged, the planet wheels 3 cannot transfer the moment from the input shaft 1 to the sun wheel 2, since the ring gears 6.1 and 6.2 participate in the rotation.

Because of the one-way bearing 24, the transfer of moment will take place via the bearing 24, and the output shaft 2 will rotate at the same speed as the input shaft 1, since the bearing 24 “locks” the gear.

If the brake 22 is activated, it will lock the ring gear 6.2 and cause the planet wheels 3 to rotate about their shaft 4.

Since the gear stages 6.1 and 6.2 are firmly connected, the sun wheel is caused to rotate at a speed which is greater than and with the same direction of rotation as the input shaft 1. In this state of operation, the one-way bearing 24 is free.

If the other brake 21 is activated at the same time as the first brake 22 is disengaged, the planet wheels 3 will rotate at an even higher speed, since the gearing between the outer ring and the stage 6.1 is higher than the first-mentioned gearing.

The output shaft 2 will hereby be brought to the greatest possible speed of rotation.

It will be appreciated that more than the mentioned three stages may be provided in the gear, it being possible to construct gears with an arbitrary number of gear stages with the same structure.

1. A multistage planetary gear incorporated in a gear housing and comprising an outer ring, planet wheels and a sun shaft, characterized in that a clutch (8) is mounted between the driving part (7) of the gear and the outer ring (6), which clutch (8), in the engaged state, transfers the driving movement to a toothed rim (6) provided on the planet shaft (4), while, in the disengaged state, it transfers the movement directly to the outer ring (16).

2. A planetary gear according to claim 1, characterized in that the clutch (8) is of the electromagnetic type which may be remote-controlled (10).

3. A planetary gear according to claim 1, characterized in that the tooth engagement between the clutch part and the planet shaft (4) comprises an internal toothing on the clutch part and an external toothing (6) on the planet shaft (4).

4. A planetary gear according to claim 1, characterized in that the clutch (8) is a centrifugal clutch comprising clutch elements (13) which, in radially extending tracks (14) in the drive plate (7), are capable of coupling the drive movement with the outer ring (16) at a high speed and of decoupling at a lower speed and thereby of transferring the movement via the tooth engagement (6).

5. A planetary gear according to claim 4, characterized in that the tracks (14) are evenly distributed with an equidistant mutual spacing on the drive plate (7).

6. A planetary gear according to claims 4 and 5, characterized in that the individual clutch elements (13) are provided with a transverse recess in which a tensile spring (15) extends to pull the elements (13) toward the axis of rotation.

7. A planetary gear according to claim 1, characterized in that there are two sets of planet wheels, a primary set (26) and a secondary set (18), and wherein the primary set (26), via a brake (8, 15), may either be held relative to the gear housing (20) or be caused to rotate freely with the ring gear (1).

8. A planetary gear according to claim 7, characterized in that the holding of the primary planet set (26) to the gear housing (20) transfers the movement, with an opposite direction of rotation, to the planet shaft (18) of the secondary set via the primary sun shaft (17) to a resulting high speed of rotation of the secondary sun shaft (19), the output shaft.

9. A planetary gear according to claim 1, characterized in that the planet wheels (3) have two or more ring gears, which each are connected with the gear housing via a brake (8, 21, 22), said brakes (21, 22) being capable of optionally braking for each ring gear (6.1, 6.2) and thereby selecting the speed of rotation of the sun shaft (2).

10. A planetary gear according to claim 9, characterized in that a one-way bearing (24) is mounted between the sun shaft (2) and the ring gears (6.1, 6.2) such that the gearing is 1:1 when the brake (8, 21, 22) is disengaged.
